(19) United States
(12) Patent Application Publication
(10) Pub. No.: US 2003/0164841 A1
(43) Pub. Date: Sep. 4, 2003

(54) System and method for passive three-dimensional data acquisition

(75) Inventor: Kenneth J. Myers, Dobbs Ferry, NY (US)

Correspondence Address: BACON & THOMAS, PLLC, 625 SLATERS LANE, FOURTH FLOOR, ALEXANDRIA, VA, 22314

(73) Assignee: Edward Greenberg

(21) Appl. No.: 10/122,386

(22) Filed: Apr. 16, 2002

Related U.S. Application Data
(63) Continuation-in-part of application No. 10/084,932, filed on Mar. 1, 2002.

(51) Int. Cl. G09G 5/00

(52) U.S. Cl. 345/619

(57) ABSTRACT

A method and system of passively acquiring three-dimensional data concerning an object relies on comparison of changes in dimensions of the background object relative to changes in dimensions of a foreground pattern or patterns as the effective optical path length between the foreground patterns and a corresponding receiver or receivers is varied, and/or on comparison of changes in positions of the background object relative to the grid as the position of the grid in a direction perpendicular to the direction of the background object is varied.

This application is a Continuation-In-Part of U.S. patent application Ser. No. 10/084,932, filed Mar. 1, 2002.

### BACKGROUND OF THE INVENTION

1. Field of the Invention

The present invention relates to passive three-dimensional data acquisition, i.e., acquisition of data correlated to three-dimensional spatial coordinates of a subject, by comparing changes in apparent dimensions and positions of target objects relative to at least two spaced-apart foreground images. The foreground images may be grids or other patterns relative to which the dimensions and/or positions of target objects in the background image can be determined.

The principle of acquiring three-dimensional data by observing changes in position or size of an object relative to spaced-apart or moving foreground images is the same as that employed by nature to achieve stereoscopic vision in humans and other animals. Essentially, images from different eyes are relayed by optic nerve cells to sets of neurons in the brain. The optic nerve cells form spaced-apart grids or patterns against which the coordinates and positions of the two images are compared to provide a sense of distance and size. Similarly, in the system and method of the present invention, by measuring the amount by which the apparent object size and/or position changes between two spaced apart grids or patterns, one can not only calculate the distance to the object, but also the distance to each point on the object that is within the resolution of the image capture device, thereby providing data on the exact z-axis or three-dimensional coordinates of points on the object. While it is of course well-known to measure distance by triangulation, triangulation only measures the distance to the point at which the sides of the triangle intersect, whereas the method and system of the present invention enables instantaneous determination of distances to all points in an image, and therefore the acquisition of “three-dimensional” data.

The system and method of the invention may be used in any application that requires acquisition of three-dimensional information about a subject, including modeling and/or analysis of three-dimensional subjects, stereoscopic imaging, and surveillance. The images may be visible light images, infrared images, ultraviolet and x-ray images, and even images formed by radiation other than light, such as alpha or beta particle radiation.

One especially advantageous application of the system and method of the invention is for passive detection and identification of moving targets, such as incoming missiles and aircraft, since the third-dimension or z-axis data is obtained without the need for scanning of the target by a projected beam or pattern, and therefore without revealing the position of the observer.

Another especially advantageous application of the system and method of the invention is for three-dimensional rendering or modeling. By utilizing multiple cameras or receivers positioned around a subject, each camera or receiver being arranged to capture an image of the subject relative to spaced-apart foreground images, it is possible to obtain 360° stereoscopic images of the subject without scanning or projection of grids that might make the subject uncomfortable, that might call attention to the imaging (for example, in law enforcement or homeland security applications), or that might affect the object of the imaging (for example, of a quantum level scientific experiment). Alternatively, the invention may use receivers or cameras that capture the background image relative to more than two spaced-apart foreground images, receivers or cameras that are movable or pivotable, and combinations of fixed and movable receivers or cameras, depending on the application.

In order to facilitate comparison between the background image and the foreground grids or patterns, the receivers may incorporate composite mirror structures that selectively reflect the grid pattern to a receiver at a different at wavelengths other than that of the background.

2. Description of Related Art

Copending U.S. patent application Ser. Nos. 09/969,583, filed Oct. 4, 2001, 09/987,336, filed Nov. 14, 2001, and 10/050,538, filed Jan. 18, 2002, disclose systems and methods of stereoscopic data acquisition in which one or more optical grids or other patterns are projected onto a subject, the distortion in the reflected grids revealing contours of the subject. To facilitate analysis of the reflected grids, the grids are optically separated from a combined image of the subject and grids using frequency sensitive beam splitters.

By enabling optical separation of projected grids that reflect contours of the subject, the systems and methods disclosed in U.S. patent application Ser. Nos. 09/987,336, 09/969,583, and 10/050,538 enable capture or rendering of images of a subject with sufficient rapidity to enable real time tracking of the subject in three dimensions, without the intensive image processing requirements of prior systems. However, projected grid systems of the type disclosed in the prior patent applications have the disadvantages that projection of the grids reveals information not only about the subject, but also about the projector. In the case of military or surveillance applications, projection of a grid or other pattern reveals the existence and/or location of the projector, rendering the projector vulnerable to discovery or attack. On the other hand, in applications involving microscopic images for scientific or medical analysis, projection of the grid may have the effect of disturbing a sensitive target and affecting the result of the analysis.

To overcome these disadvantages, it was proposed in parent U.S. patent application Ser. No. 10/084,932, filed March 1, to acquiring three-dimensional data in an entirely passive manner by comparing changes in the size of background and foreground images relative to fixed sets of x,y coordinates situated in two different image planes spaced apart along the z-axis parallel to the direction of the incoming image.

The present invention involves the same background-image/multiple-foreground-image comparison concept as disclosed in the parent application, but extends the concept by utilizing the fact that the spaced-apart foreground images do not, in principle, need to be spaced apart along the z-axis parallel to the direction of the incoming image, but rather may be spaced in any direction, including the direction perpendicular to the incoming image. It turns out that if the foreground images are spaced in the perpendicular direction, respective objects in the background image will change position relative to the foreground image by different amounts depending solely on distance between the respective objects and the foreground image, whereas if the foreground images are spaced in the parallel direction, objects in the background image will change size relative to the foreground image by different amounts depending solely on the distance to the background image. Each of these variations of the basic concept of the invention have advantages, the latter resulting in a more compact structure, and the former reducing the number of calculations (relative position being somewhat easier to determine than relative size), simplifying camera structure, and increasing the brightness and/or resolution of images by reducing the number of beam splitters in the image path.

### SUMMARY OF THE INVENTION

It is accordingly a first objective of the invention to provide a system and method for capturing three-dimensional image data that does not require scanning or illumination of the subject by a grid or other pattern, and that therefore may be characterized as “passive.”

It is a second objective of the invention to provide a passive three dimensional image capture system having improved image quality and resolution.

It is a third objective of the invention to provide a passive three dimensional image capture system having simpler hardware and software requirements.

It is a fourth objective of the invention to provide a passive three dimensional image capture system that may easily be adapted to capture three-dimensional data at different wavelengths, for example at both visible light and infrared wavelengths.

It is a fifth objective of the invention to provide a passive image capture system and method that is capable of capturing three-dimensional data concerning an object, including distance to the object, size of the object, and identification of object characteristics based on three-dimensional renderings, and yet which requires only minimal image processing and relatively simple and inexpensive hardware, such as a digital camera modified to include a reference grid.

These objectives are accomplished, in accordance with the principles of a preferred embodiment of the invention, by providing a system and method for acquiring data correlated with three-dimensional geometric features or location of objects by comparing changes in the position and/or size of objects with two spaced-apart foreground images. If the foreground images are spaced-apart in a direction perpendicular to the direction of the incoming background image, then the preferred embodiment compares positions of the points in the background image relative to the two foreground images, whereas if the foreground images are spaced-apart in a direction parallel to the direction of the incoming background image, then the preferred embodiment compares sizes of the objects or features in the background image relative to the two foreground images. If the foreground images are spaced in both the perpendicular and parallel directions, then the preferred embodiment compares both size and position of objects or features in the background relative to the two foreground images.

The method of the invention, in its broadest form, involves three steps:

a. Capturing a first composite image of a background object or objects and a first foreground pattern or grid;

b. Capturing a second composite image of the background object(s) and a second foreground pattern or grid that is spaced from the first foreground pattern or grid;

c. Comparing the relative sizes and positions of features of the background object(s) and the foreground in the two composite images relative to a fixed set of coordinates.

If the background object is stationary relative to the observer, then the method of the invention may easily be carried out by (i) using a camera equipped with a grid or reference pattern to capture a first image of the background object at a first position, moving the camera, and capturing a second image of the background object at the second position, or (ii) capturing two images of the background object at different focal lengths using a zoom or interchangeable lenses.

Although the successive image capture method is intended to be within the scope of the invention to the extent permitted by the prior art, the more practical applications of the invention involve tracking of moving targets, in which case the composite foreground/background images to be compared must be captured simultaneously, and thus the method of a preferred embodiment of the invention includes the steps of:

a. Capturing a first composite image of a background object or objects and a first foreground pattern or grid;

b. Capturing a second composite image of the background object(s) and a second foreground pattern or grid that is spaced from the first foreground pattern or grid;

c. Comparing the relative sizes and positions of features of the background object(s) and the foreground in the two composite images relative to a fixed set of coordinates.

This method differs from the first preferred method in that the images are captured simultaneously. In addition, a step of moving the image capture devices may be added, as follows:

d. Before capturing the first and second composite images, aiming image capture devices containing the first and second foreground pattern or grids at one of the background objects.

The difference between an implementation of the simultaneous capture embodiments in which the cameras are parallel and one in which the cameras are aimed at the subject is that in the former implementation, object position changes are a function solely of distance from the camera or observer, whereas in the latter implementation the background object, or point on the background object, at which the cameras are aimed remains stationary relative to the grids while all other objects or points move relative to the grids by amounts that are a function of distance relative to the distance to the background object or point at which the cameras are aimed (the absolute distance to the background object or point being easily determined by triangulation).

Those skilled in the art will appreciate that the terms “spaced-from” or “spaced-apart” encompass not only physical spacing, but differences in the optical path achieved by mirrors, lenses, or other optical elements that can lengthen or shorten the apparent spacing, and/or change an apparent position.

According to a preferred system for implementing the above-described simultaneous composite image capture methods, the foreground images are preferably in the form of grids, although the foreground images may take other forms, including images of potential targets that can be matched to observed targets. The paths are varied, in the preferred embodiments, by placing the image capture devices at separate locations, for example in separate camera units, by using beam splitters to split the background image and direct it to the two different foreground images, and/or by placing optical elements such as lenses or mirrors in the optical path.

The three-dimensional data acquisition devices or cameras of the invention may be used individually in a variety of surveillance applications, or may be arranged in pairs or groups of multiple fixed or movable cameras for use in stereoscopic imaging applications, including any of the stereoscopic imaging applications described in the above-cited copending applications.

In addition to providing an improved 3D imaging system and method, the invention also provides a unique mirror construction that enables the foreground grid or pattern to more easily be separated from the background for processing. This is accomplished by treating a surface of a reflective or beam-splitting mirror in such a manner that a grid is formed on the mirror surface, either through the used of a coating, by forming the mirror of different materials, or by appropriate surface treatment methods, such that the grid or pattern reflects a different set of wavelengths than the remaining surface of the mirror. For example, the mirror may include a grid, each of the lines of which reflect a full spectrum of light, while the squares formed by the grid reflect only selected wavelengths. Separation of the images reflected by the grid lines and the squares may then be achieved by using receivers sensitive to the different wavelengths, or by wavelength-sensitive beam splitting arrangements of the type disclosed in copending U.S. patent application Ser. Nos. 09/969,583, 09/987,336, and 10/050,538.

### BRIEF DESCRIPTION OF THE DRAWINGS

FIGS. 1A and 1B are flowcharts showing variations of a method of passive three-dimensional data acquisition in accordance with the principles of the invention.

FIGS. 2 and 3 are schematic diagrams showing apparatus which may be used to implement the method of FIG. 1A.

FIGS. 4 and 5 are schematic diagrams showing apparatus which may be used to implement the method of FIG. 1B.

FIGS. 6-14 are schematic diagrams showing a few of the ways in which the apparatus of FIGS. 4 and 5 may be varied by arranging grids and beam splitters in different combinations.

FIGS. 15-18 are schematic diagrams showing further variations of the apparatus illustrated in FIGS. 4 and 5, arranged to capture thermal profiles of objects.

FIGS. 19A and 19B are, respectively, a plan view and a perspective view of a mirror construction suitable for use in connection with the imaging systems illustrated in FIGS. 1-18.

FIGS. 20 and 21 are schematic diagrams of further variations of the cameras illustrated in FIGS. 2 and 3.

FIG. 22 is a schematic diagram of a passive three-dimensional data acquisition system constructed in accordance with another preferred embodiment of the invention, in which the foreground grids or patterns are spaced in a direction perpendicular to the direction of the incoming image.

FIG. 23 is a schematic diagram illustrating the manner in which background object size and/or position changes with distance in the system of FIG. 23.

FIG. 24 is a schematic diagram of a variation of the system illustrated in FIGS. 22 and 23.

FIG. 25 is a schematic diagram illustrating the manner in which background object size and/or position changes with distance in the system of FIG. 24.

### DETAILED DESCRIPTION OF THE PREFERRED EMBODIMENTS

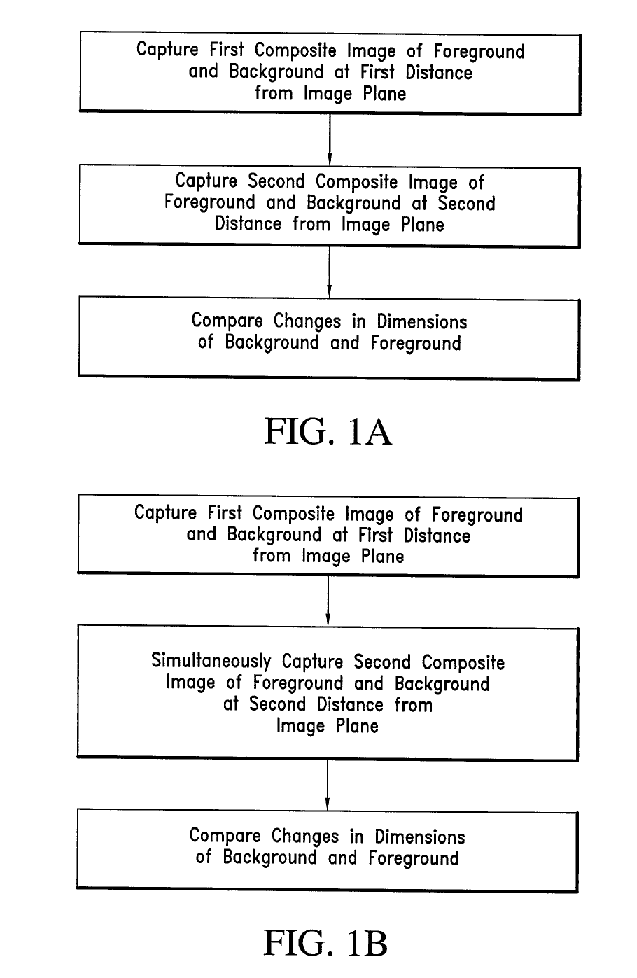

As illustrated in FIG. 1A, a method of acquiring three-dimensional data according to the principles of the invention, in its broadest implementation, involves the following three steps:

a. Capturing a first composite image of a background object or objects and a first foreground pattern or grid (step 100);

b. Capturing a second composite image of the background object(s) and a second foreground pattern or grid that is spaced from the first foreground pattern or grid (step 110);

c. Comparing the relative sizes and positions of features of the background object(s) and the foreground in the two composite images relative to a fixed set of coordinates (step 120).

If the background object or objects of interest are stationary relative to the observer, then the method of the invention may be carried out by capturing successive images at different locations relative to the object, for example by changing the focal length of the camera or by moving the camera.

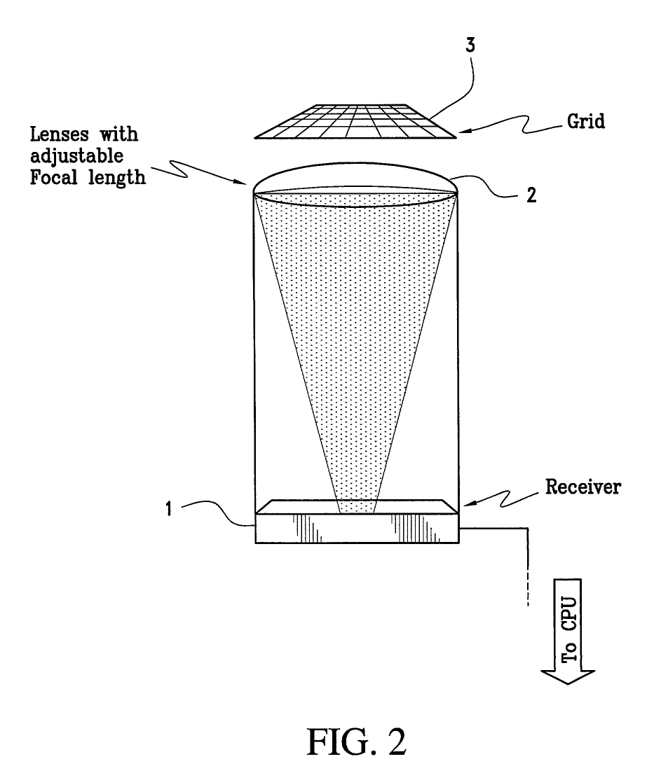

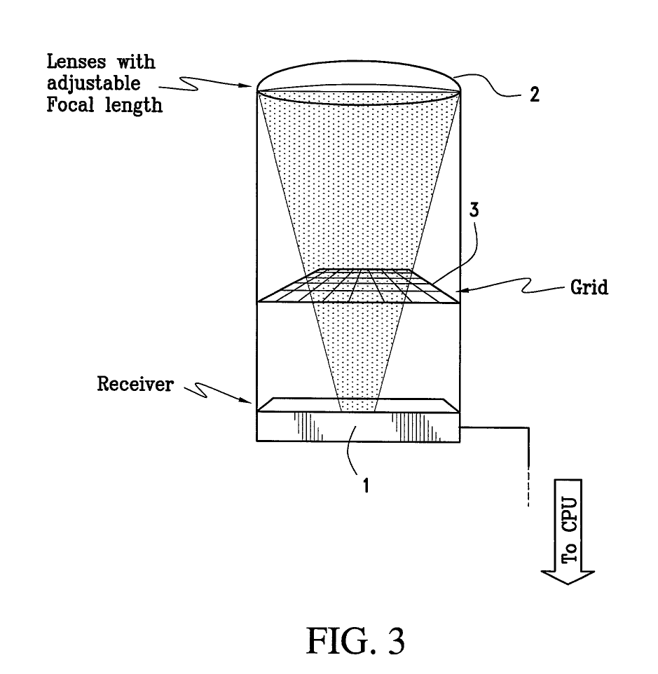

The camera may be an ordinary digital camera having a CCD 1 situated at the image plane, and one or more lenses 2 for varying the effective distance between from the image plane to the foreground image 3, as illustrated in FIGS. 2 and 3.

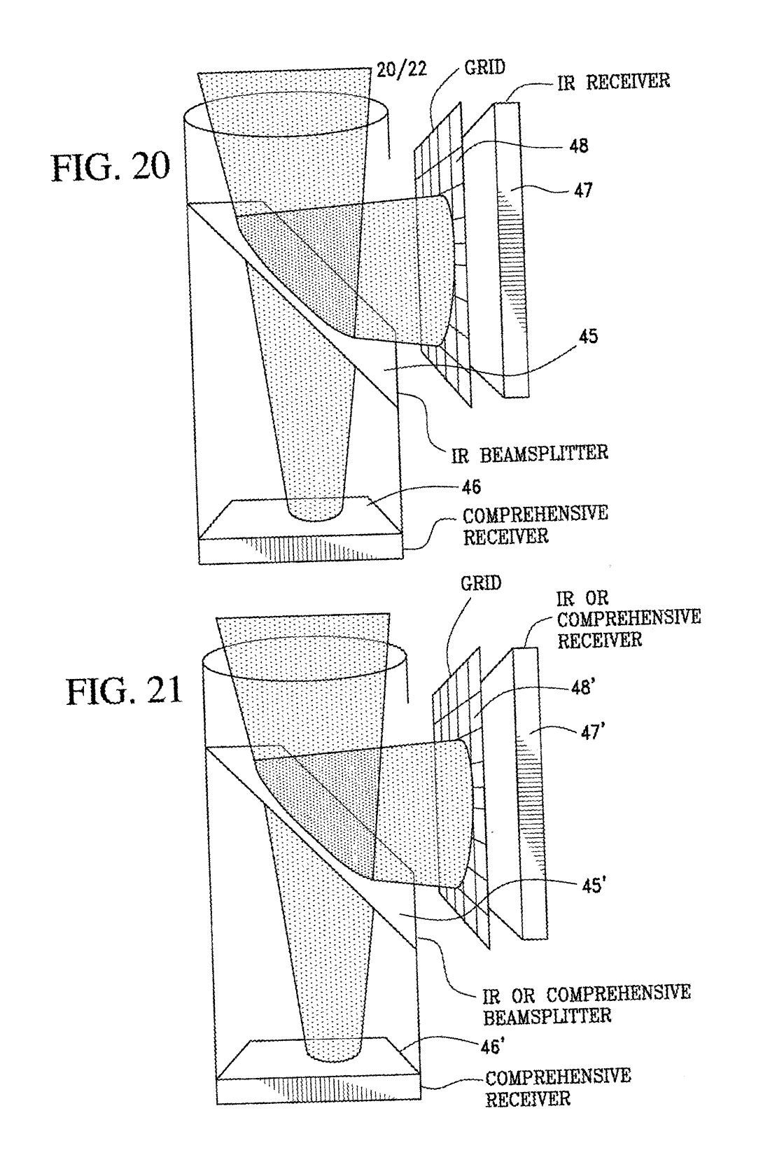

Alternatively, the camera may include a beam splitter 45, 45′ and image capture devices 46, 46′, 47, 47′, one of which is provided with a grid 48,48′, as illustrated in FIGS. 20 and 21. This alternative camera enables capture of a composite background/foreground image and an image without the background, and enables the composite image to captured at wavelengths than the background image only, depending on the wavelength sensitivities of the beam splitters 45, 45′ and respective receivers 46, 46′, 47, 47′. In FIG. 20 beamsplitter 45 is an infrared beam splitter, while image capture device 46 is a comprehensive visible/infrared receiver and image capture device 48 is an infrared receiver. In FIG. 21, beam splitter 45′ may reflect either infrared only or visible and infrared light, and receiver 46′ may be sensitive to infrared only or visible and infrared light. In either arrangement, sensitivity to other wavelengths may be substituted of added with respect to the beam splitters and/or any of the receivers, and the grids may be replaced by other patterns or images, such as masks that can be used to determine relative size.

The cameras of FIGS. 2, 3, 20, and 21 may be used to capture successive images of relatively stationary subjects at different grid positions by either moving the cameras after capturing the first image and before capturing the second image, or by optically varying the incoming image path, for example, by changing the focal length of the camera lens after capturing the first image and before capturing the second image.

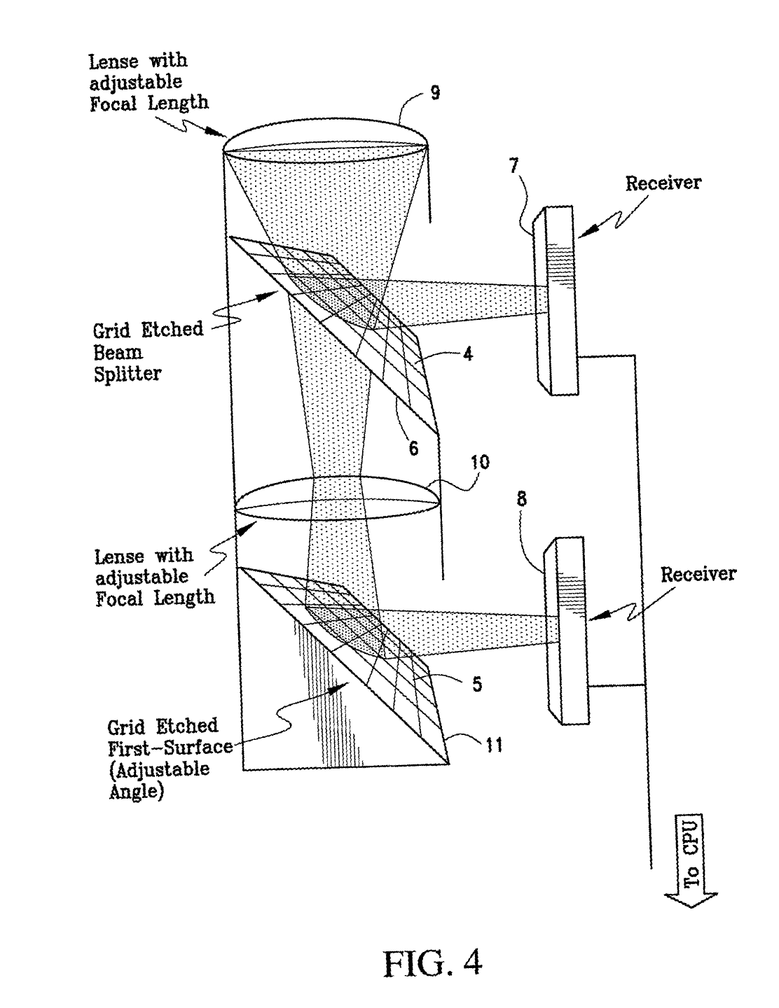

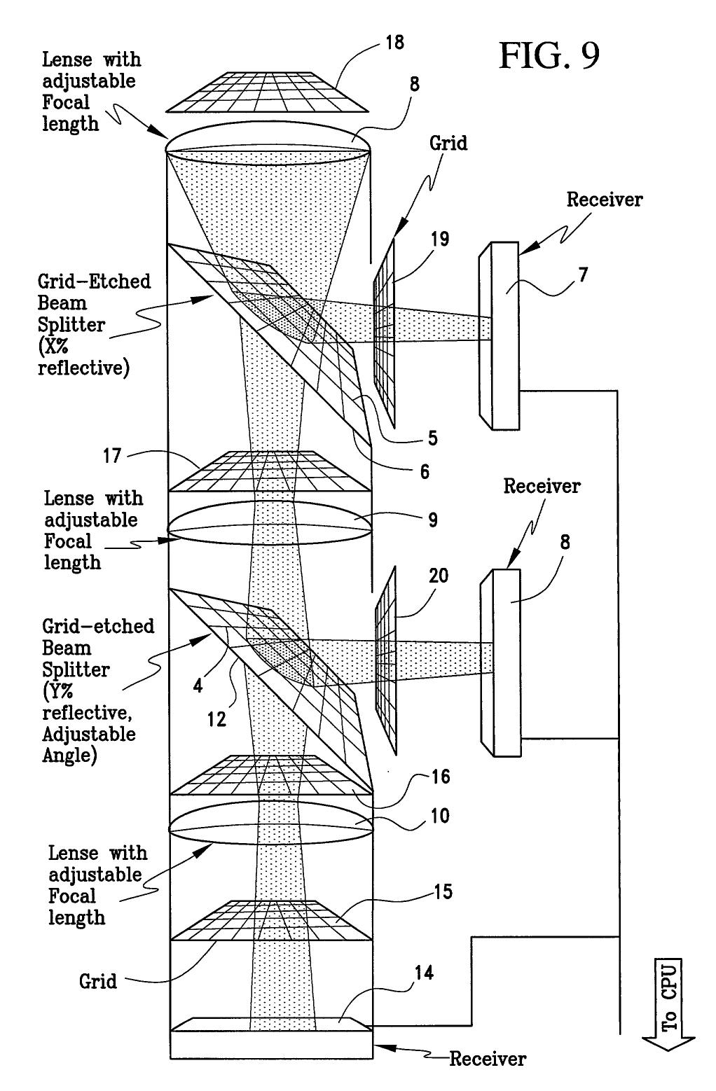

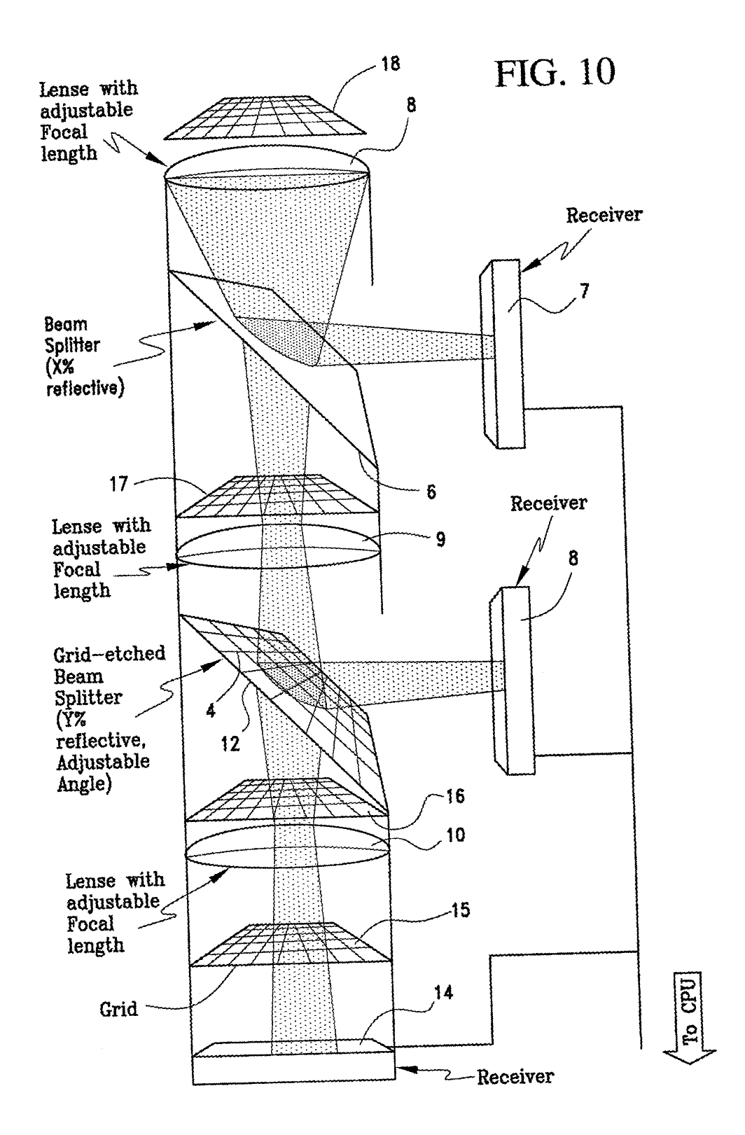

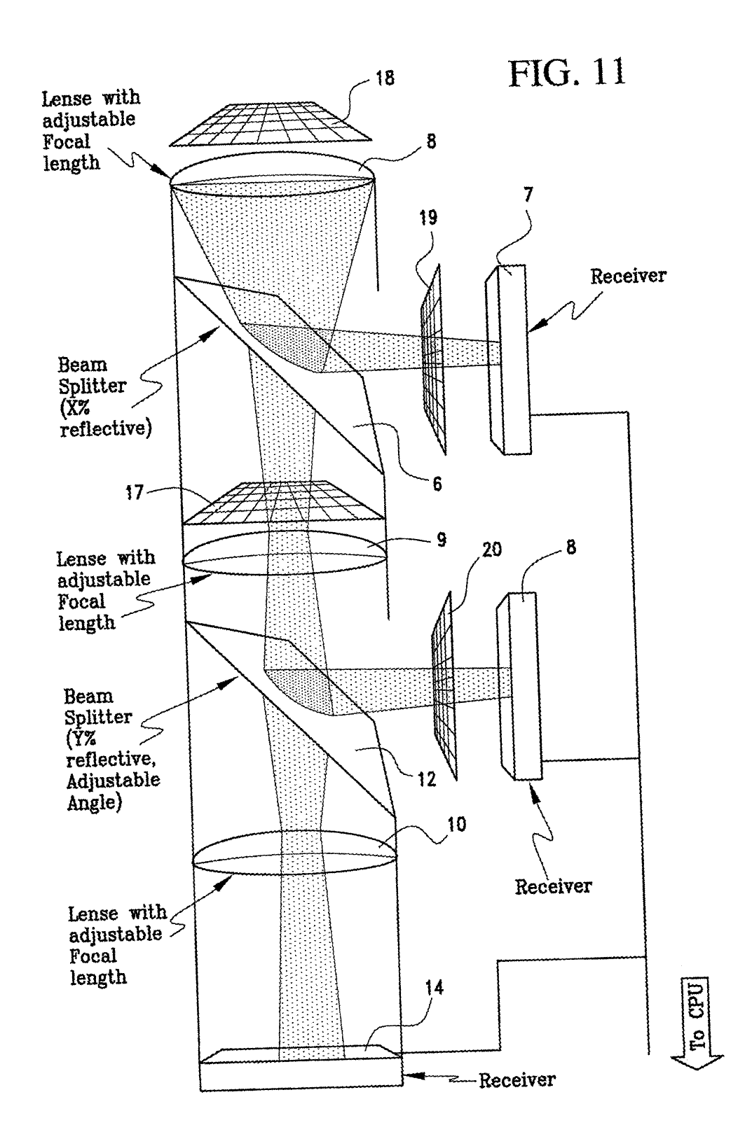

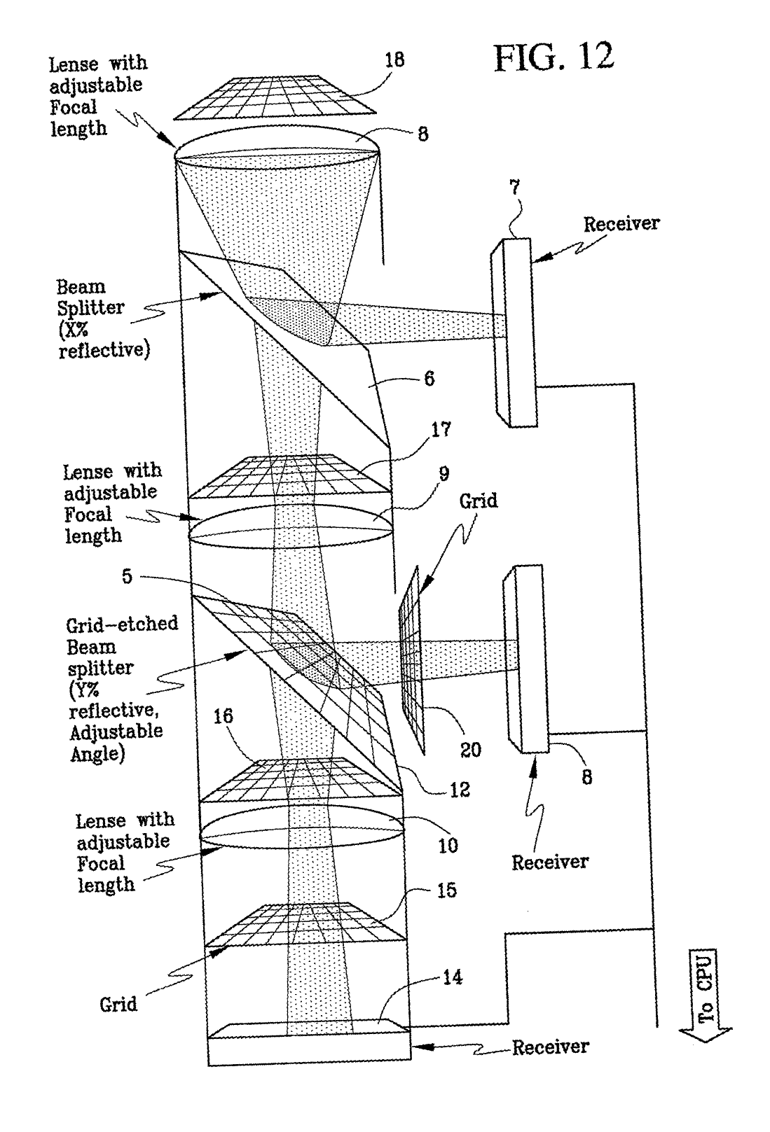

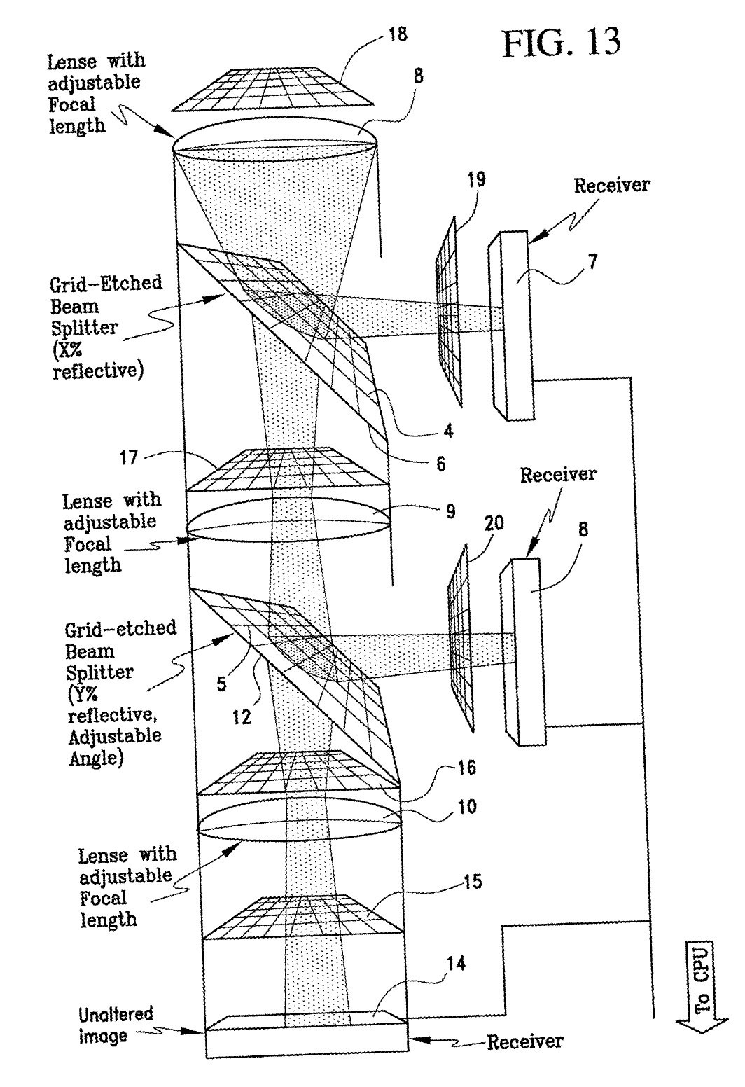

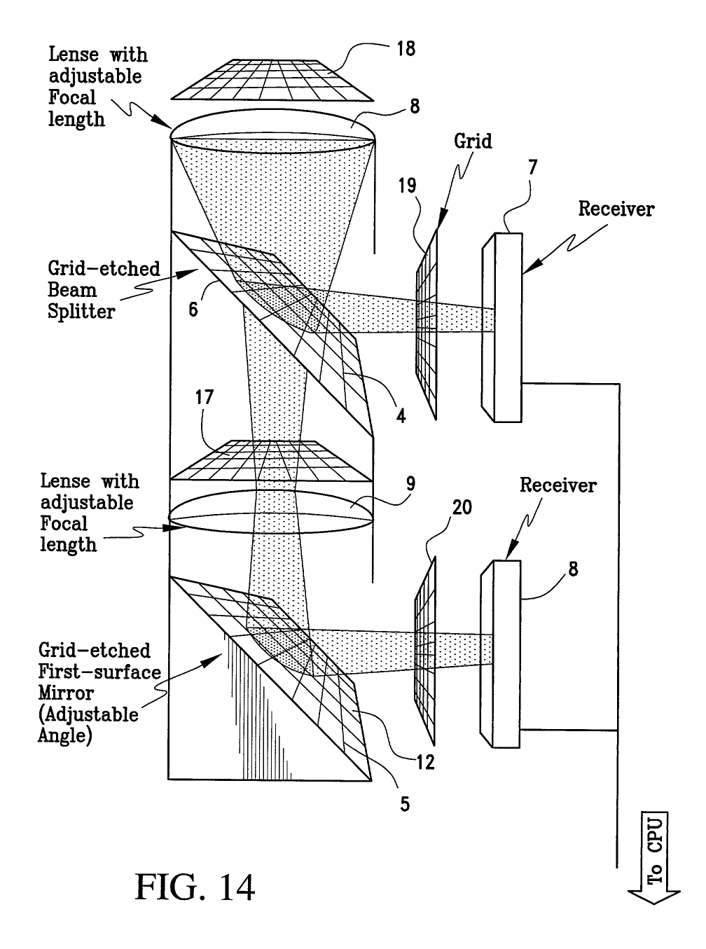

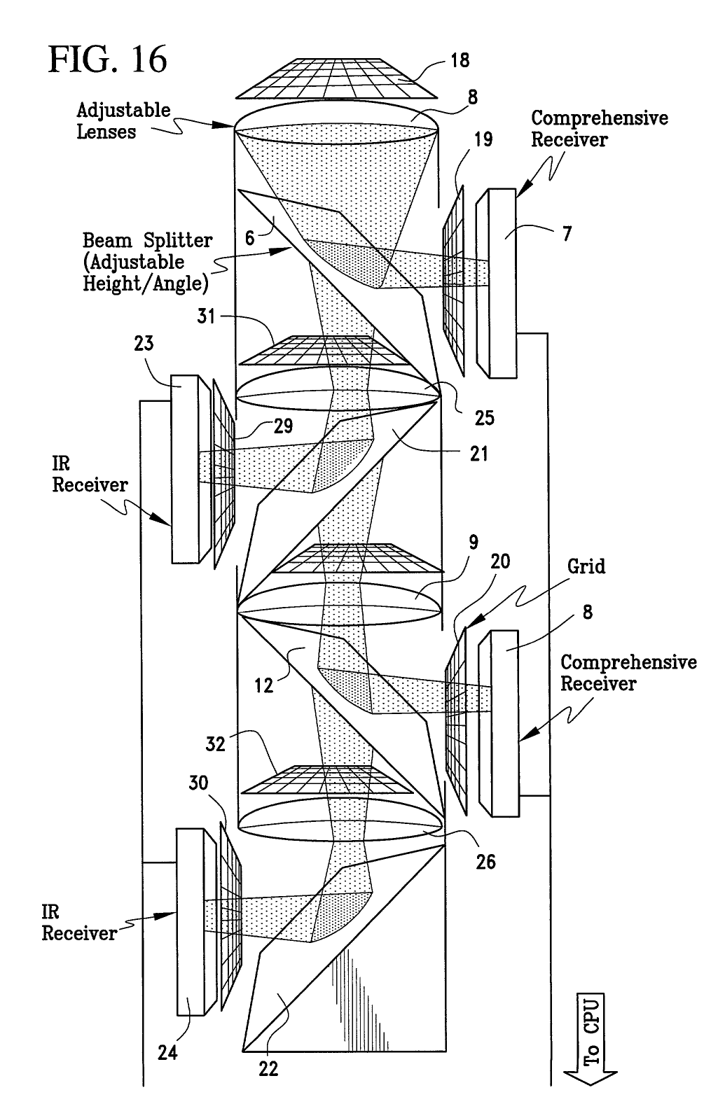

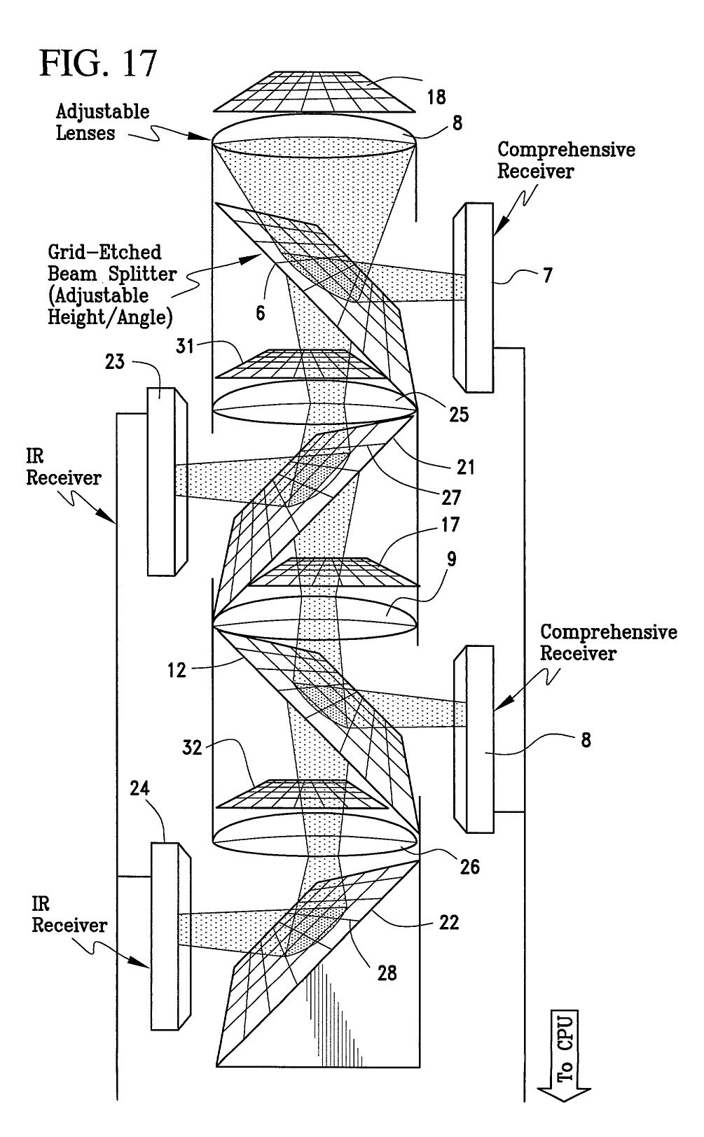

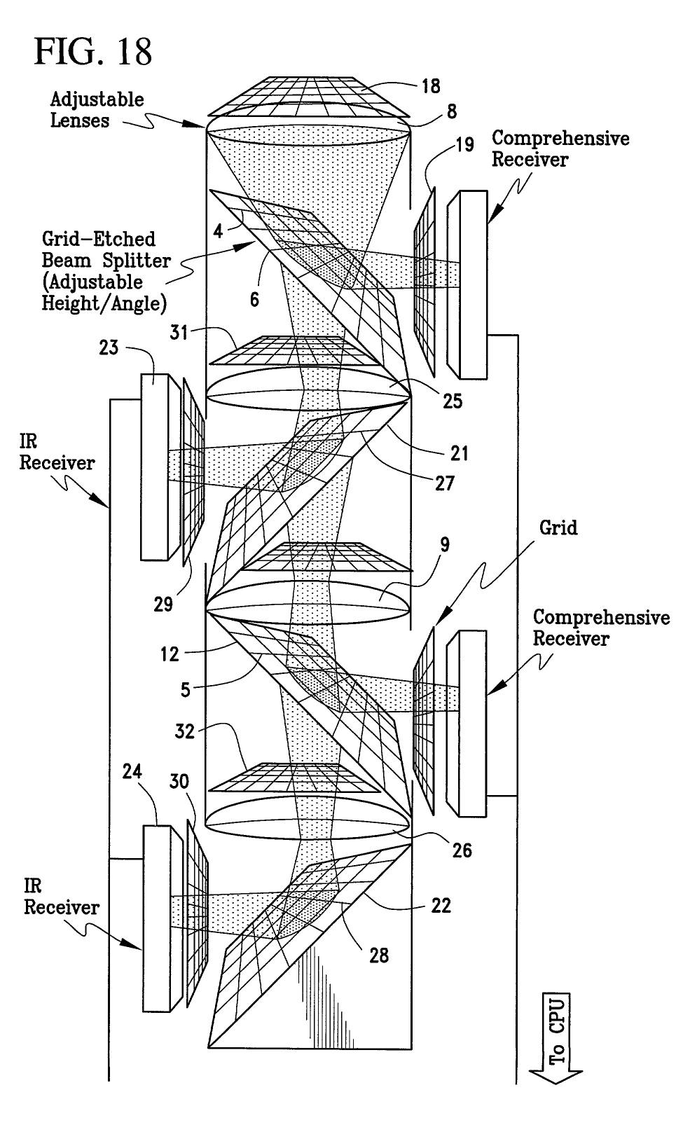

The cameras illustrated in FIGS. 2, 3, 20, and 21 may also be used to acquire three-dimensional data concerning moving subjects, by positioning the cameras in spaced-apart relationship. Alternatively, two spaced apart grids and corresponding image capture devices may be placed into a single camera, as illustrated in FIGS. 4-19.

In such applications, the images to be compared must be captured simultaneously rather than successively, and thus the method of this preferred embodiment of the invention preferably includes, as illustrated in FIG. 1B, the steps of:

a. Capturing a first composite image of a background object or objects and a first foreground pattern or grid (step 210);

b. Capturing a second composite image of the object(s) and a second foreground pattern or grid that is spaced from the first foreground pattern or grid (step 220);

c. Comparing the relative sizes and positions of features of the background object(s) and the foreground in the two composite images relative to a fixed set of coordinates (step 230).

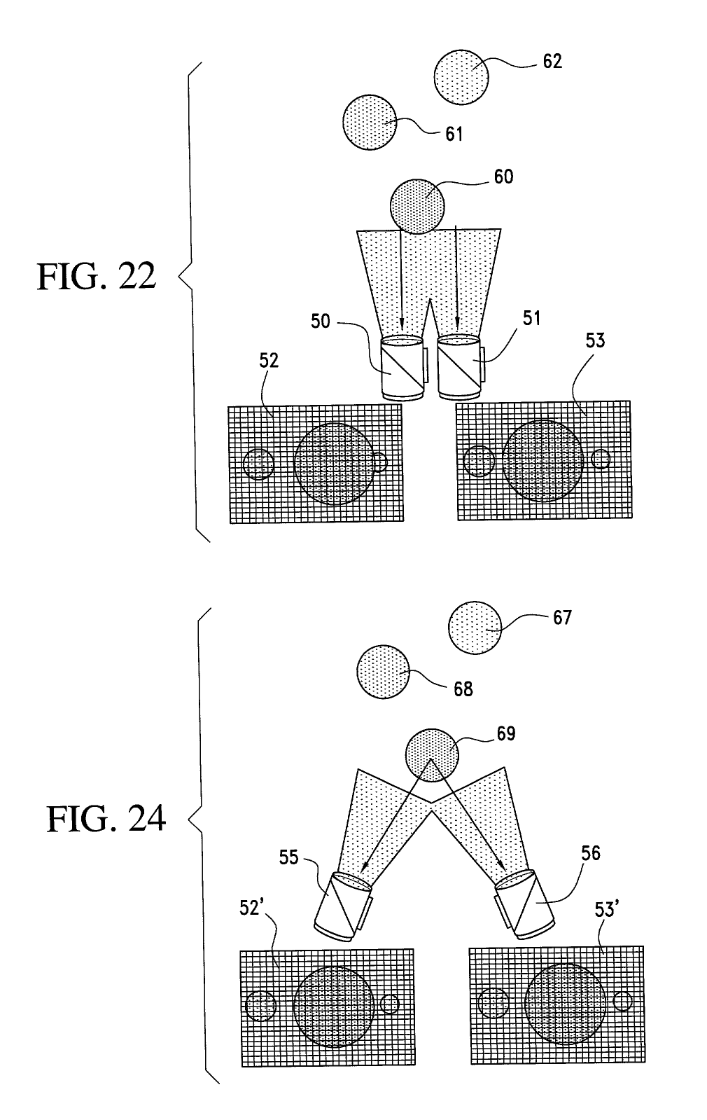

In the side-by-side or perpendicularly-spaced (with respect to the direction of the incoming image) implementation of the simultaneous capture embodiment of the invention, as illustrated in FIG. 22, cameras 50 and 51 with grids 52 and 52 (schematically represented in enlarged form below the cameras, but actually mounted in the manner illustrated in FIGS. 2, 3, 20, and 21) are fixed with respect to each other and oriented in parallel. The cameras 50,51 may be integrated into a single housing or implemented as separate units, with the spacing being a matter of convenience and desired resolution, and the entire dual-camera assembly may be fixed or movably mounted.

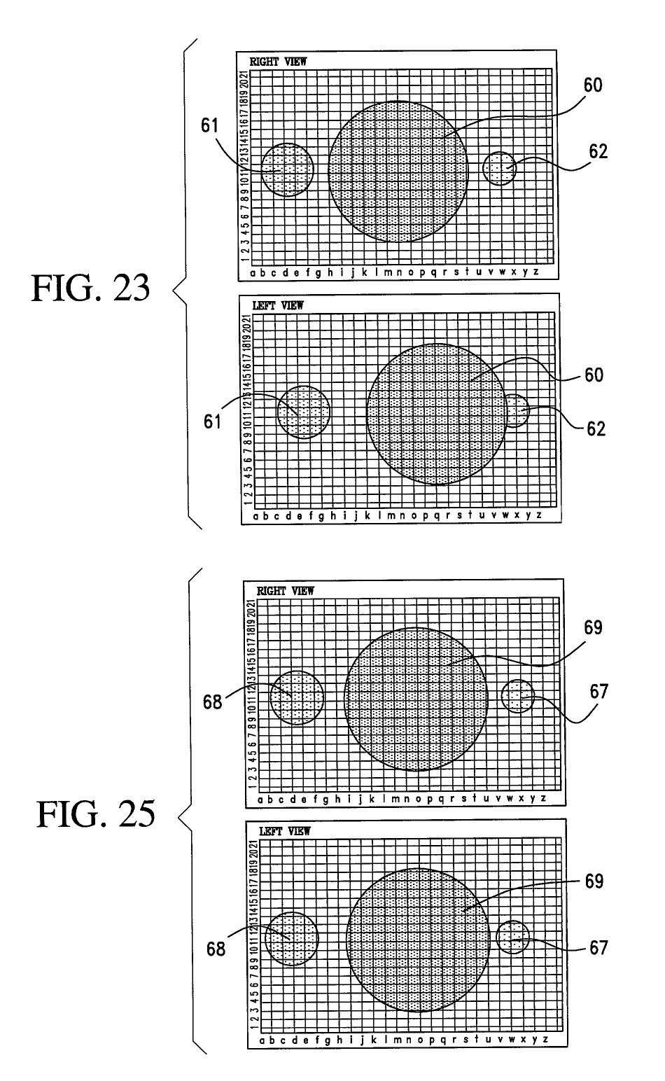

The system illustrated in FIG. 22 works by capturing changes in the position of the object relative to the grid, as illustrated in FIG. 23. In particular, the closer object will be shifted by a greater amount that the more distant objects, thus permitting the distance to be determined. For example, object 60 in FIG. 23 is shifted between the two images by approximately 3 grid lines while object 61 is shifted by just one grid line because it is further from the cameras, and object 62 is shifted by just one-half grid line. Those skilled in the art will appreciate that the amounts by which images of the objects are shifted is solely a function of distance and not of the size of the objects, and that the relationship between the shifts and distances involves simple geometry.

In an alternate implementation of perpendicularly spaced camera arrangement illustrated in FIG. 22, cameras 55 and 56 are independently pivotally mounted so that they may be aimed at one of the objects (step 300 in FIG. 1B). This arrangement is equivalent to that illustrated in FIG. 22, but the shifts are measured relative to the object at which the cameras are aimed or pointed, i.e., the object at which the cameras are pointed will always be in the center of the image while more distant and closer objects will shift be greater amounts depending on distance from the object at which the cameras are pointed. For example, as illustrated in FIG. 25, object 67 shifts by the greatest distance in the two images, while object 68 shifts by a smaller distance, and object 69 remains stationary relative to the foreground grid.

Because this implementation captures distances relative to object 68 rather than to the observer, i.e., cameras 55 and 56, the absolute distance to object 68 (if of interest) must be separately determined (step 310 in FIG. 1B). However, such separate determine can easily be accomplished by triangulation, based on the angles of the two cameras and their spacing.

It is noted that this implementation appears similar to a conventional range finder that uses triangulation to determine the distance. However, the resemblance is only superficial. Instead of determining the distance to the point at which the cameras are aimed, the system of the invention determines the distance to all objects in the background image, and furthermore to all features of those objects, providing a complete three-dimensional rendering of the entire scene, and of all objects within the field-of-view of the system.

Instead of providing separate or perpendicularly spaced cameras, it is also possible to capture three-dimensional data by varying the optical path lengths between two spaced, parallel foreground images and separate image capture devices within a single camera, as illustrated in FIGS. 4-19.

This is accomplished in the implementation illustrated in FIG. 4, by using at least one beam splitter 6 to split the background image and direct it through the two different foreground images 4,5 to different receivers 7,8 located in different image planes, and/or by placing optical elements such as lenses 9,10 and/or mirror(s) 11 having selected focal lengths in the optical path.

Those skilled in the art will appreciate that the use of lenses or other optical elements such as mirrors having different focal lengths is useful for increasing the apparent separation between the image planes in which the relative sizes of the foreground and background images are to be compared, but that in principle the simultaneous superposition of the background image on foreground images that are a different optical distance from the image planes should be sufficient to acquire useful three-dimensional information.

A critical requirement for the acquisition of meaningful three-dimensional data in the implementations of FIGS. 4-19 are that the foreground images be at different apparent distances or optical path lengths from the background. So long as this requirement is met, the optical path lengths may be further varied in any convenient manner without affecting the operation of the system. For example, the optical path lengths may be controlled by varying the focal lengths of lenses 9 and 10, or grids 4 and 5 may be physically moved relative to the receivers 7 and 8, by a motor, piezoelectric actuator, or the like. The term “apparent” is used because the grids may have different sizes, necessitating corresponding changes in the optical path dimensions.

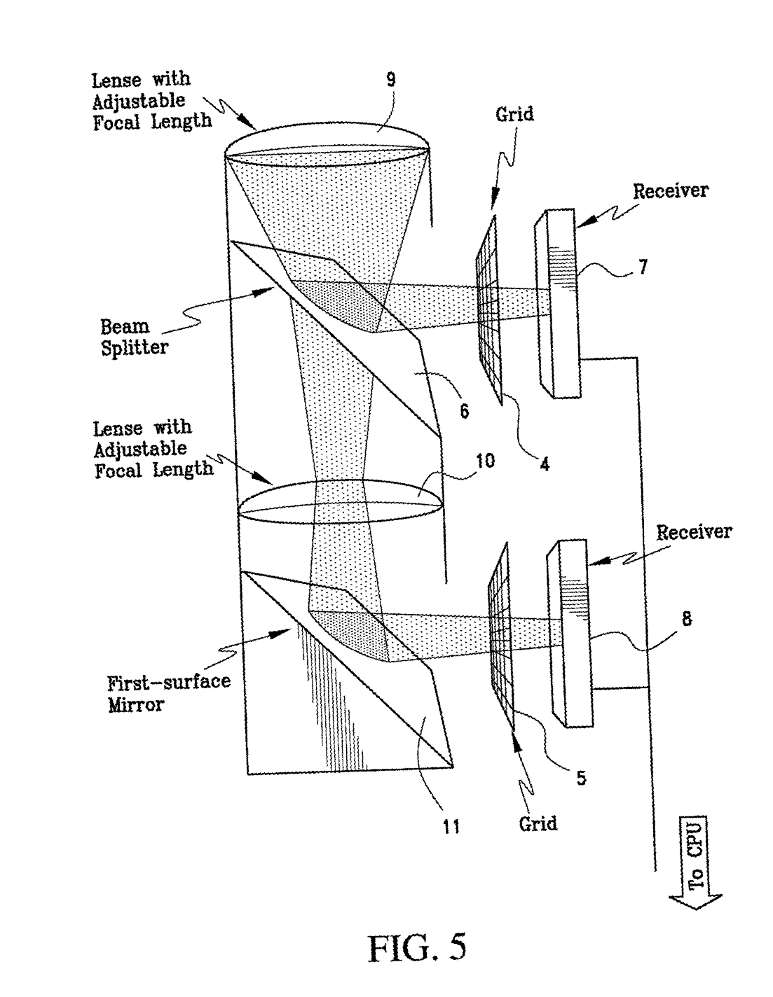

The difference between the embodiment illustrated in FIG. 4 and the embodiment illustrated in FIG. 5 concerns the placement of the foreground images, i.e., the grids of patterns 4,5. In the embodiment of FIG. 4, the grids 4,5 are situated on the beam splitter 6 and a mirror 11 that directs the background image to the second receiver, for example by etching the grid into a surface of the beam splitter and mirror, while in the embodiment of FIG. 5, the grids are positioned between the beam splitter and mirror and the receivers 7,8. In addition, in the embodiment illustrated in FIG. 4, mirror 11 may be made adjustable to compensate for the apparent change in position of the grid 5 resulting from adjustment of the focal length of lens 10, while in the embodiment of FIG. 5, mirror 11 may be deleted and the receiver and grid positioned directly below the beam splitter.

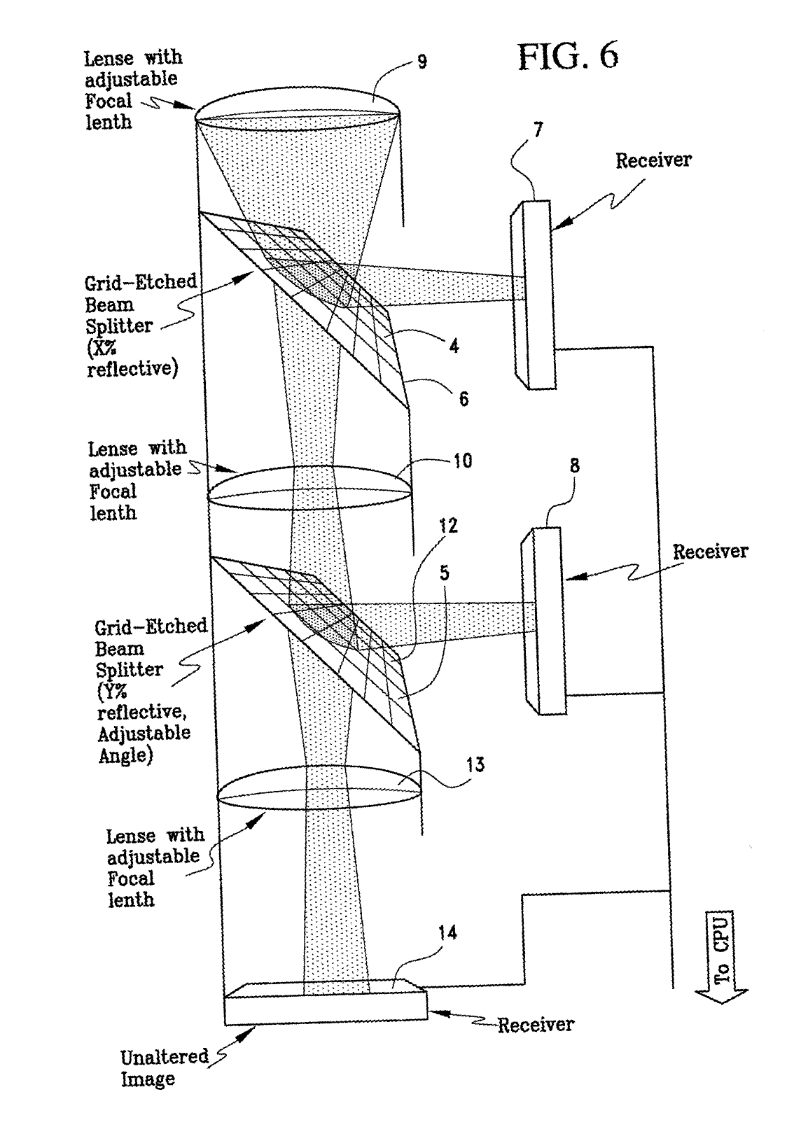

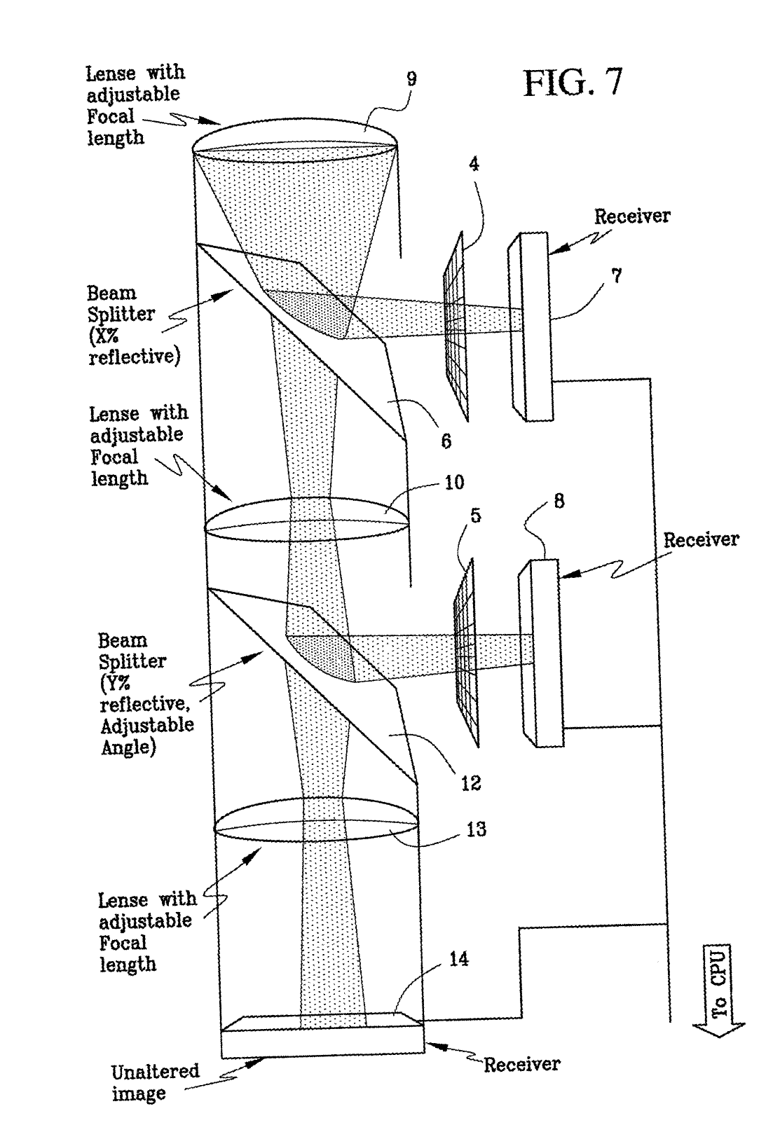

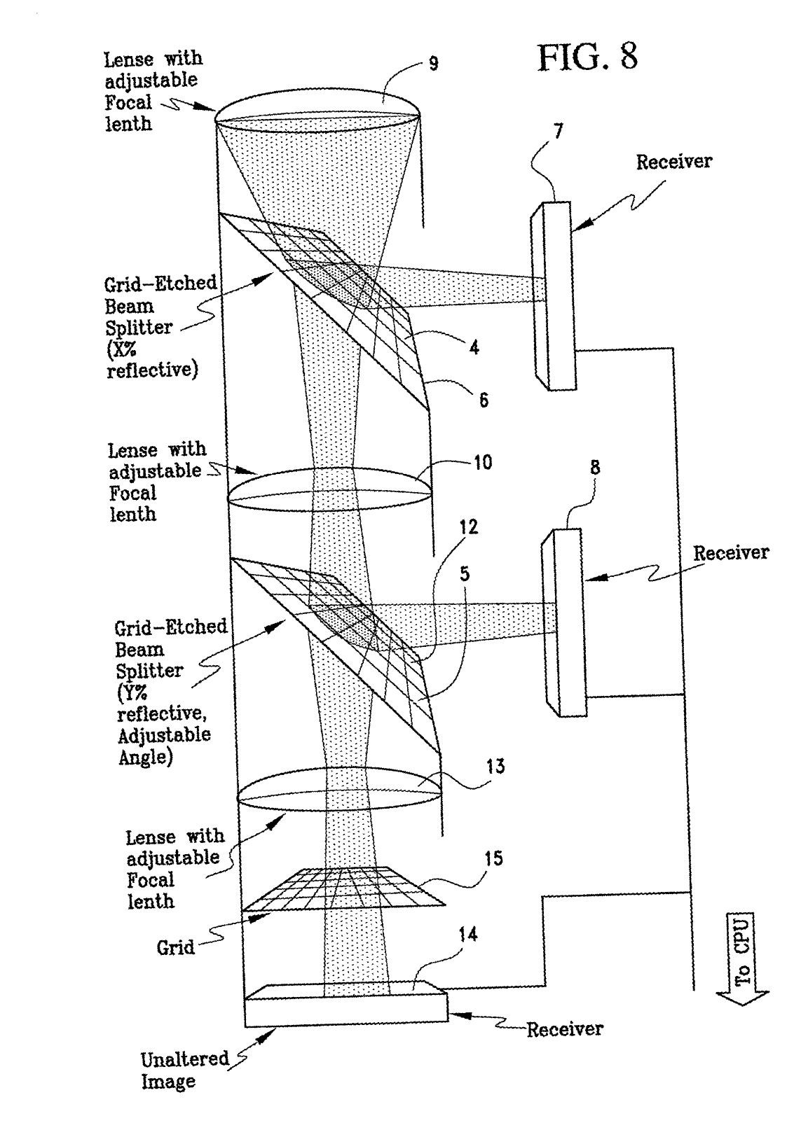

In the embodiment illustrated in FIGS. 6 and 7, mirror 11 of FIGS. 4 and 5 is respectively replaced by a second beam splitter 12, and a third adjustable focal length lens 13 and receiver 14 are added in order to provide a reference image which may be used for calibration purposes, i.e., to decrease the effects of uncertainties or tolerances in the first two optical paths. In addition, the third optical path and/or the first and second optical paths (whether or not a third optical path is provided) may include any combination of one or more further grids or reference patterns 15, 16, 17, 18, 19, and/or 20 while omitting any of grids 4 or 5, as illustrated in FIGS. 8-14, which show a variety, but not all, of the different combinations of grids, lenses, and beam splitters that fall within the scope of the invention.

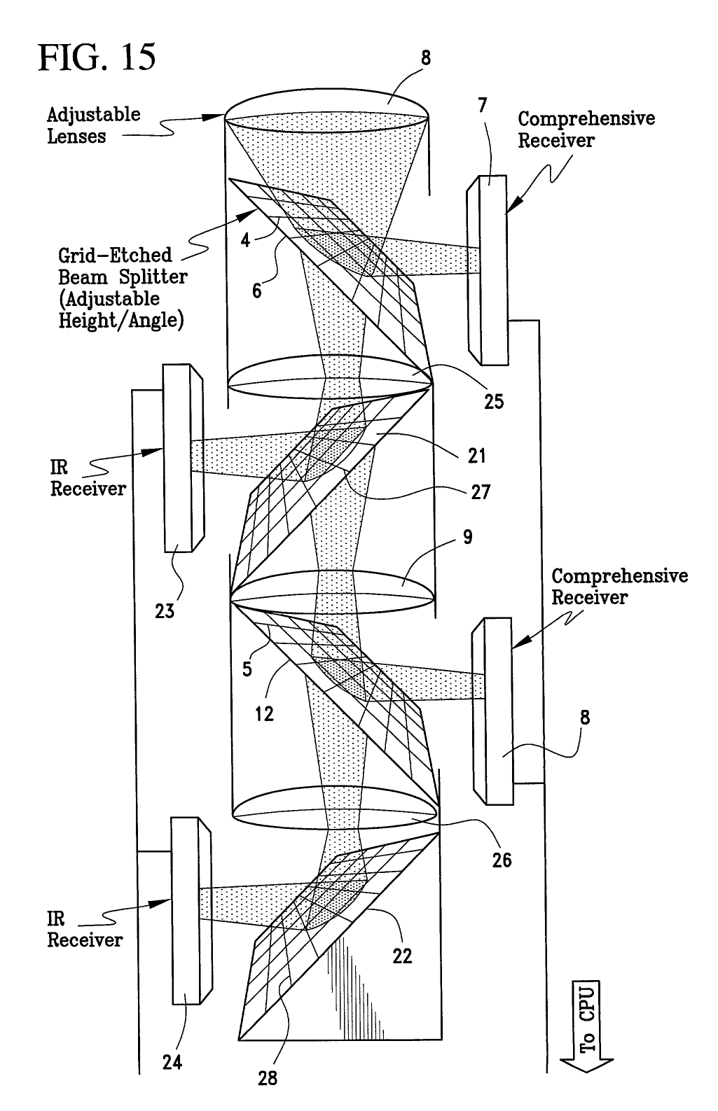

Finally, as illustrated in FIGS. 15-18, additional beam splitter 21, mirror 22, receivers 23, 24, lenses 25, 26, and grids 27-32 may be added to separate out different wavelengths of the background image, either by using wavelength sensitive beam splitters, by using specific wavelength sensitive receivers, or by a combination of the wavelength sensitive beam splitters and receivers. For example, infrared receivers may be used to acquire temperature data in order to form a thermal profile of an object in the background image, which is useful for tracking and identification of incoming missiles or aircraft, although the wavelength sensitive receivers need not be limited to infrared receivers. It will be appreciated that it may also be desirable to separate each of the grids by frequency even in visible light applications, so that each image clearly includes a separate grid.

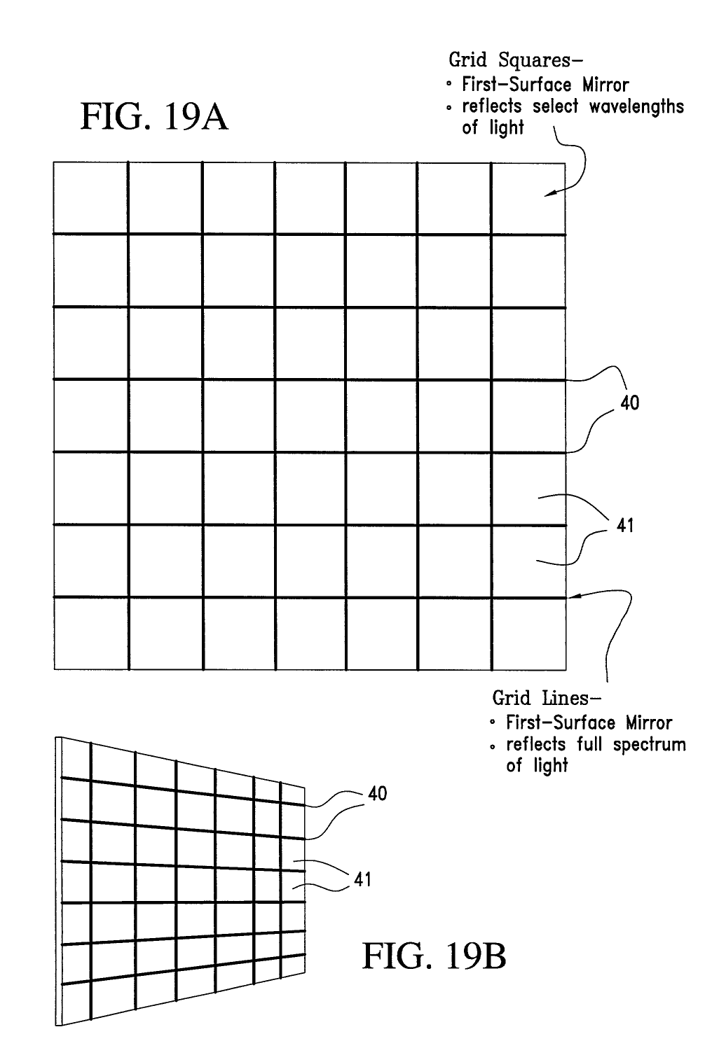

To facilitate separation or processing of the foreground grid or pattern, any of the preferred embodiments of the invention may utilize the unique mirror construction illustrated in FIGS. 19A and 19B. This is accomplished by treating a surface of a reflective or beam-splitting mirror in such a manner that a pattern is formed on the mirror surface, either through the use of a coating, by forming the mirror of different materials, or by appropriate surface treatment methods, such that the pattern reflects a different set of wavelengths than the remaining surface of the mirror. For example, the pattern may be a grid 40, each of the lines of which reflect a full spectrum of light, while the squares 40 formed by the grid reflect only selected wavelengths. Alternatively, the grid may be selectively reflective while the squares reflect a full-spectrum or a different spectrum than that reflected by the grid. Separation of the images reflected by the grid lines and the squares may then be achieved by using receivers sensitive to the different wavelengths, or by wavelength-sensitive beam splitting arrangements of the type disclosed in copending U.S. patent application Ser. Nos. 09/969,583, 09/987,336, and 10/050,538.

Having thus described various preferred embodiments of the invention in sufficient detail to enable those skilled in the art to make and use the invention, it will nevertheless be appreciated that numerous variations and modifications of the illustrated embodiment may be made without departing from the spirit of the invention.

For example, multiple data acquisition or imaging devices corresponding to those of the preferred embodiment may be combined or linked together to generate stereoscopic 360° images, and the devices may otherwise be modified for integration into a variety of apparatus or systems, including computer-based modeling, rendering, and/or design systems, defense, homeland-security, or law enforcement related surveillance systems, detectors for use in physics, chemistry, and other scientific experiments, and in vehicle guidance systems.

In addition, the cameras may be integrated into portable or hand-held devices, helmets or visors, or fixed installations including, by way of example and not limitation, airport security check points, satellites, radar sites, and in vehicles.

It is therefore intended that the invention not be limited by the above description or accompanying drawings, but that it be defined solely in accordance with the appended claims.

I claim:

1. A method of acquiring data correlated with three-dimensional geometric features or location of at least one object in a background image, comprising the step of passively acquiring the data by comparing capturing composite images of the object and first and second spaced-apart foreground grids or patterns, and determining a distance to said object based on shifts in positions or sizes of said objects relative to said first and second grids or patterns.

2. A method as claimed in claim 1, wherein said composite images are captured successively, before and after moving an image capture device an integral foreground grid or pattern from a first position to a second position, the integral foreground grid or pattern forming, at said first and second positions, said first and second foreground images or patterns.

3. A method as claimed in claim 1, wherein said composite images are captured successively, before and after changing a first focal length to a second focal length of an image capture device that includes an integral foreground grid or pattern, the integral foreground grid or pattern forming, at respective said first and second focal lengths, said first and second foreground images or patterns.

4. A method as claimed in claim 1, wherein said composite images are captured simultaneously.

5. A method as claimed in claim 4, wherein said composite images are captured simultaneously by spaced, mutually parallel, image capture assemblies, and said step of determining said distance comprises the step of comparing positions of said object relative to said first and second grids or patterns.

6. A method as claimed in claim 4, wherein said composite images are captured simultaneously by spaced image capture assemblies that are aimed at said object, and said step of determining said distance comprises the step of determining distances of said object relative to other objects in the image based on shifts in position of said other objects relative to said grids or patterns.

7. A method as claimed in claim 6, further comprising the step of determining a distance from the image capture assemblies to said object by triangulation.

8. A method of acquiring data correlated with three-dimensional geometric features or location of a subject, comprising the steps of:
a. Capturing a first composite image of a background object and a first foreground pattern or grid;
b. Capturing a second composite image of the object and a second foreground pattern or grid that is spaced from the first foreground pattern or grid;
c. Comparing the relative sizes or positions of features of the background object and the foreground in the two composite images relative to a fixed set of coordinates established by said foreground patterns or grids.

9. A method as claimed in claim 8, wherein steps a and b are performed simultaneously.

10. A method as claimed in claim 9, wherein said foreground patterns or grids are spaced apart in a direction perpendicular to the direction of the background object, and wherein distances to objects in said image are determined based on amounts by which positions of said objects relative to said grid are shifted.

11. A method as claimed in claim 10, wherein image capture devices are oriented substantially in parallel relative to each other, and said distances are distances from said image capture devices to said objects.

12. A method as claimed in claim 10, further comprising the step of aiming image capture devices at said background object, wherein said distances are relative distances between said background object and other objects, and an absolute distance to said background object is determined by triangulation.

13. A method as claimed in claim 9, wherein said images are spaced apart in a direction parallel to the direction of the background object, and wherein distances to objects in said images are determined based on amounts by which sizes of said objects change relative to the grid in said two composite images.

14. A method as claimed in claim 8, wherein the foreground patterns or grids are grids.

15. A system for acquiring data correlated with three-dimensional geometric features or location of a subject, comprising a camera arrangement for capturing two composite images of a background object through a foreground pattern at different positions relative to the background object, and means for comparing the two composite images in order to determine the amount by which sizes or dimensions of the background change relative to dimensions of the foreground image at said different positions.

16. A system as claimed in claim 15, wherein said camera arrangement includes two parallel, spaced apart cameras each including at least one said foreground pattern.

17. A system as claimed in claim 15, wherein said camera arrangement includes two spaced apart cameras that are pivotable mounted and arranged to be pointed at said background object.

18. A system as claimed in claim 15, wherein said camera arrangement includes a single camera that includes two said foreground patterns, and two receivers for simultaneously capturing said composite images through the two respective foreground patterns.

19. A system as claimed in claim 15, wherein said foreground patterns are grids.

20. A system as claimed in claim 15, wherein said camera arrangement includes at least one camera having at least one beam splitter for splitting an image of the background object and directing the image to separate optical paths through the respective foreground patterns.

21. A system as claimed in claim 20, wherein at least one of said foreground patterns is situated on said beam splitter.

22. A system as claimed in claim 20, wherein said one of said foreground patterns is a grid etched into said beam splitter.

23. A system as claimed in claim 22, further comprising a mirror having an adjustable angle for directing a composite background/foreground image at said second receiver.

24. A system as claimed in claim 23, wherein a second of said foreground patterns is a grid etched into said mirror.

25. A system as claimed in claim 20, wherein at least one of said foreground patterns is situated between said at least one beam splitter and a corresponding said receiver.

26. A system as claimed in claim 25, wherein a second of said foreground patterns is situated between said at least one beam splitter and a corresponding second one of said receivers.

27. A system as claimed in claim 20, wherein a number of said beam splitters is at least two, and a number of said receivers is at least three.

28. A system as claimed in claim 20, wherein a number of said foreground patterns is at least three.

29. A system as claimed in claim 28, wherein said foreground patterns are grids.

30. A system as claimed in claim 20, further comprising at least one second beam splitter and at least one third receiver arranged to capture a composite image of the background image and a foreground pattern at selected wavelengths that differ from a set of wavelengths to which said first and second receivers are responsive.

31. A system as claimed in claim 30, wherein said selected wavelengths are infrared wavelengths.

32. A system as claimed in claim 31, further comprising a second infrared beam splitter and receiver.
